(19) United States
(12) Patent Application Publication
(10) Pub. No.: US 2026/0103975 A1
(43) Pub. Date: Apr. 16, 2026

(54) DIGITIZATION OF RASTER WELL LOGS USING MULTIMODAL PROMPTING AND COMPUTER VISION TECHNIQUES

(71) Applicant: Landmark Graphics Corporation, Houston, TX (US)

(72) Inventors: Rakshitha Rao Ailneni, Richardson, TX (US); Geetha Gopakumar Nair, Houston, TX (US); Pradyumna Singh Rathore, Bangalore (IN)

(21) Appl. No.: 18/917,270

(22) Filed: Oct. 16, 2024

(51) Int. Cl. E21B 47/002; G06T 7/13; G06T 7/149

(52) U.S. Cl. CPC E21B 47/002; G06T 7/13; G06T 7/149

(57) ABSTRACT

A computer-implemented method, computer-readable medium, and system for digitizing well log data. The method comprises at least obtaining well log data related to one or more geological formations within the Earth’s subsurface, wherein the well log data is contained in an image format file; processing the image format file using contour detection to extract bounding boxes for at least one data curve, the contour detection steps including extracting a plot region and detecting a header for the at least one data curve; extracting scale and depth values for at least one plot region from the bounding boxes; processing the header through visual question answering to extract curve properties of the at least one data curve from the header; processing the extracted curves and the plot region through text-guided segmentation, the text-guided segmentation producing masked patches of the at least one data curve; and digitizing the data curve.

### TECHNICAL FIELD

This disclosure relation generally to the field of drilling a wellbore in a subsurface formation and more particularly to the field of digitizing raster well log data using multimodal prompting and computer vision techniques.

### BACKGROUND

In the drilling of a wellbore in subsurface formations, the geology of the target formation and surrounding formations may be mapped to visualize the various layers withing the Earth’s subsurface. The mapping of the geological formations may be utilized when planning a wellbore and steering a drill bit through one or more of the geological formations such that a wellbore is positioned in a target zone. Specific data points are important for mapping and modeling and are costly to extract from well logs using traditional methods and tools.

### BRIEF DESCRIPTION OF THE DRAWINGS

Implementations of the disclosure may be better understood by referencing the accompanying drawings.

FIG. 1 is a schematic of an example well system, according to some implementations.

FIG. 2 is a chart depicting a process for digitizing data files, according to some implementations.

FIG. 3 is a more detailed chart depicting a portion of the data process shown in FIG. 2, according to some implementations.

FIG. 4 is a more detailed chart depicting another portion of the process shown in FIG. 2 in conjunction with FIG. 3, according to some implementations.

FIGS. 5A-5C are example data charts and graphs illustrating data processes using the digitizing process disclosed herein, according to some implementations.

FIG. 6 is an example illustration of an original image of a curve transformed to a binary mask, according to some implementations.

FIG. 7 is an example illustrating the integrity of the digitizing process disclosed herein, according to some implementations.

FIG. 8 is a flowchart depicting example operations to digitize data, according to some implementations.

FIG. 9 is a block diagram depicting an example computer, according to some implementations.

### DETAILED DESCRIPTION

The description that follows includes example systems, methods, techniques, and program flows that embody aspects of the disclosure. However, it is understood that this disclosure may be practiced without these specific details. For instance, this disclosure refers to generating images of the geological formations while drilling a wellbore. Aspects of this disclosure can also be applied to any other periods in the process of drilling a wellbore. For clarity, some well-known instruction instances, protocols, structures, and operations have been omitted.

Example implementations relate to digitizing geological data for a wellbore in the form of well logs (Raster logs) to be used for wellbore planning, drilling, and hydrocarbon recovery. The geological formations below the Earth’s surface may have different features such as color, texture, grain size, etc. The geological formations may also include anomalies such as natural fractures, faults, etc. Data may be collected from geological formations from various sources, and may be collected as data logs, such as Raster logs. Raster logs may be formatted in large image files, such as high resolution tagged image file format (TIFF) files that may be digitized for better visualization and presentation of desired data points. For example, when planning a wellbore, the data from the well logs may be utilized while drilling a wellbore in one or more of the geological formations or be utilized to steer a drill bit through a target formation such that the drill bit does not penetrate the boundaries between the target formation and the surrounding geological formations. In some implementations, the features and/or anomalies may not be available for the current geological formations in which the wellbore is being drilled. Thus, data and measurements of the target and/or surrounding geological formations are useful for mapping the geological formations.

Conventional geological maps and modeling may be based on well log data obtained while drilling the wellbore and/or offset wellbore measurements. The data logs used in wellbore modeling are often provided in Raster logs in a TIFF format. The conversion of Raster logs of well log data in TIFF format into a digitized format such as Log ASCII standard (LAS) file is traditionally a rigorous manual process. The data log files may be very large, huge in fact, and have multiple data curves therein. It is difficult to identify a specific curve that the user wants with traditional digitization tools and manual digitization. Because of the huge resolution of the input TIFF file, it requires high computation; resources to use abject detection models for detecting the header and plot region. For example, the process to digitize at least 1000 logs to support an AI modeling prediction may take at least 200 days using traditional methods and available products, which imparts a high monetary, personnel, and time cost. The solution disclosed herein may also apply to other large image format files, including Portable Network Graphics (PNG) files, Joint Photographic Experts Group (JPEG) files, etc.)

Disclosed herein are embodiments of an automated process to extract and digitize one or more data curves from well log data. Implementations may include a method, a non-transitory computer readable medium, and a system for extracting and digitizing any data curve that a user wants to view and isolate from a large image format file, such as a TIFF file. The digitized data curve may be presented as an LAS file for further use with planning, drilling, or evaluating a wellbore or subterranean areas surrounding the wellbore. The solution provided herein may be used to extract any curve from the data and may be a fully automated process.

The well log data may be obtained from logging while drilling (LWD), measuring while drilling (MWD), and similar pre-production or production data collection techniques. The well log data is compiled into Raster logs. Embodiments disclosed herein convert the Raster logs in TIFF format to LAS (digitized) format using a combination of Visual Question Answering (VQA) and text-guided segmentation, which may then be used for modeling of a wellbore or geological formations. An input TIFF file may include multiple data curves, including at least, but not limited to gamma ray, resistivity, and inclination, and may represent several log types, including, for example, sonic, density, caliper, wireline, LWD, and MWD. The solution presented herein helps the user extract a specific curve and digitize the specific curve. The input TIFF file image has a very high resolution (such as, for example, 1089 x 67070, 1700 x 158400 pixels) compared to traditional files and contains multiple header blocks. These challenges are addressed by dividing and converting the plot region into multiple square patches and using visual question answering to address multiple plots in a single image. To extract a plot region from the entire TIFF image, traditional computer vision techniques like contour detection are used.

Contour detection is used to produce bounding boxes of the data and detect headers within the bounding boxes. Contour detection includes edge detection of the data, merging overlapping contours, and outputting bounding boxes. Detecting the header includes extracting curve properties, including color, texture, and scale of the desired data curve (in this example, gamma ray curve) from the header using visual question answering.

Prompting methods are used to extract useful information related to the specific curve from the input TIFF file. Information pertaining to the desired data curve such as color, texture, and scale may be extracted by prompting a large vision learning model. The previous approaches just extract all the curves present in the input image, but the previous approaches can't work if the input image (TIFF file) is very large. The curve properties and vertical patches and then used for text-guided segmentation. In the disclosed embodiments, the individual patches are masked and combined with the segmented curve properties. The mask is digitized and obtained via segmentation by getting the non-zero indices and normalization. The digitized data may then provided in an LAS file format.

Many software programs and platforms currently available cannot process large image format files directly and therefore there is a need for method of computer-implemented product to digitize information of curves. The solutions described herein may provide processing or preprocessing step in some data applications. While the disclosed solutions are described in the context of gamma ray curves, the embodiments disclosed herein may also be used to segment any desired or specified data curve and digitize it. The disclosed solution may serve the same purpose in scalable earth modeling applications and all seismic workflows; provide a key role for artificial intelligence (AI) modeling of the wellbore such as (DS365.ai) and may be able to provide large-scale open source TIFF digitization for AI and machine language (ML) modeling, as well as data for stand-alone modeling. As such, the solutions provided herein provide an improvement to processing large data files, such as well log data, and digitizing the data into a more usable format, such as LAS files. Log ASCII standard (LAS) is a file format for storing well log information. Well logging may be used to investigate and characterize properties of the well and surrounding subsurface formation for hydrocarbon recovery evaluation and optimization, wellbore planning, and drilling execution and modification. A single LAS file may obtain data for one well, as well as a plurality of datasets, also called curves, from that well. Common curves may include gamma, time or travel time, or resistivity logs. TIFF files may contain multiple plot lines for other scientific and engineering disciplines, such as environmental monitoring, infrastructure inspections, or manufacturing processes.

In one implementation, a computer-implemented method includes at least obtaining well log data related to one or more geological formations within the Earth's subsurface, wherein the plurality of well log data is contained in an image format file. The image format file is processed using contour detection to extract bounding boxes for at least one data curve, the contour detection steps including extracting a plot region and detecting a header for the at least one data curve. The method further extracting scale and depth values for at least one plot region from the bounding boxes and processing the header through visual question answering to extract curve properties of the at least one data curve from the header; processing the extracted curves and the plot region through text-guided segmentation, the text-guided segmentation producing masks of individual patches of the at least one data curve; and digitizing the data curve. The digitized data curve may be presented as a Log ASCII standard (LAS) file.

Embodiments of the apparatus, systems, and/or methods as described herein provide one or more improvements in the existing technology in the field of data processing and data digitization. The solutions provided herein provide embodiments of a fully automated workflow for digitizing the data curves. In some implementations, the fully automated workflows may use large multimodal models to extract curve-specific information from the header and perform text-guided segmentation of each plot. Various embodiments as described herein also provide an improvement to the functioning of a computer. For example, the solution provided herein eliminates the need for labelled data to train or guide a custom segmentation model, and presents an optimized and automated way to digitize curves present in large image format filles, such as TIFF files.

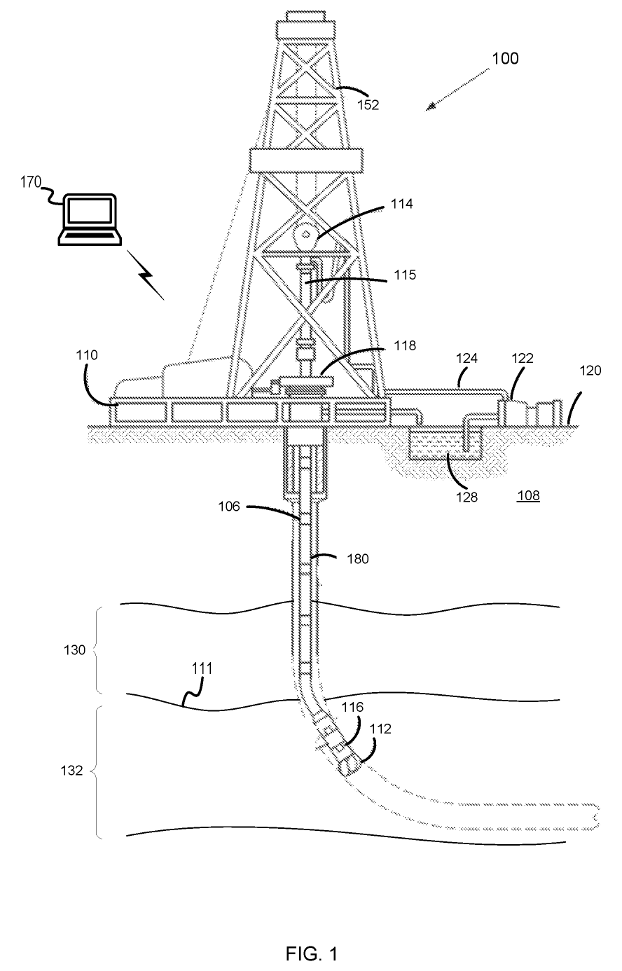

FIG. 1 is a schematic of an example well system, according to some implementations. In particular, FIG. 1 is a schematic diagram of a well system 100 that includes a drill string 180 having a drill bit 112 disposed in a wellbore 106 for drilling the wellbore 106 in the subsurface formation 108. While depicted for a land-based well system, example implementations may be used in subsea operations that employ floating or sea-based platforms and rigs.

The well system 100 may further include a drilling platform 110 that supports a derrick 152 having a traveling block 114 for raising and lowering the drill string 180. The drill string 180 may include, but is not limited to, drill pipe, drill collars, and drilling assembly 116. The drilling assembly 116 may comprise any of a number of different types of tools including a rotary steerable system (RSS), measurement while drilling (MWD) tools, logging while drilling (LWD) tools, mud motors, etc. A kelly 115 may support the drill string 180 as it may be lowered through a rotary table 118. The drill bit 112 may include roller cone bits, polycrystalline diamond compact (PDC) bits, natural diamond bits, any hole openers, reamers, coring bits, and the like. Drilling parameters of drilling the wellbore 106 may be adjusted to increase, decrease, and/or maintain the rate of penetration (ROP) of the drill bit 112 through the subsurface formation 108 and, additionally, steer the drill bit 112 through the subsurface formation 108. The subsurface formation 108 may include multiple geological formations such as geological formations 130, 132. The interface between the geological formations 130, 132 may be the formation bed boundary 111. The drilling parameters may assist in steering the wellbore 106 to avoid contact and/or penetration of the formation bed boundary 111. Drilling parameters may include weight-on-bit (WOB) and rotations-per-minute (RPM) of the drill string 180. A pump 122 may circulate drilling fluid through a feed pipe 124 to the kelly 116, downhole through interior of the drill string 180, through orifices in the drill bit 112, back to the surface 120 via an annulus surrounding the drill string 180, and into a retention pit 128.

In some implementations, various sections of the wellbore 106 such as the vertical, tangent, curve, and horizontal section may require directional drilling to steer the drill bit 112 on a planned well path and/or keep the wellbore 106 in a target formation. Sensors on the drilling assembly 116, such as gamma ray sensors, density sensors, porosity sensors, resistivity sensors, etc., may log respective measurements of the geological formations 130, 132 while drilling the wellbore 106. The measurement logs may be obtained from the sensors on the drilling assembly 116 and uplinked to the surface 120 and may be stored in a Raster log. In some implementations, the measurements may be communicated to tools on the drilling assembly 116 for processing. The measurements may be processed and utilized to determine characteristics of the geological formations 130, 132 such as features of the geological formations 130, 132, the location of the formation bed boundary 111, anomalies, fluid interfaces (such as an oil-water interface within a geological formation), etc. In some implementations, the wellbore operations may be determined based on specific data information, such as, e.g., data related to gamma rays. As such, a digitized format of the gamma ray curve data may be communicated back to the drilling assembly 116 for more concise and directed instruction to maintain or modify the planned well path and/or remain in the target formation. For example, a target formation of the wellbore 106 may be geological formation 132. Steering decisions may be implemented such that the wellbore 106 may not be drilled through the formation bed boundary 111 and into geological formation 130.

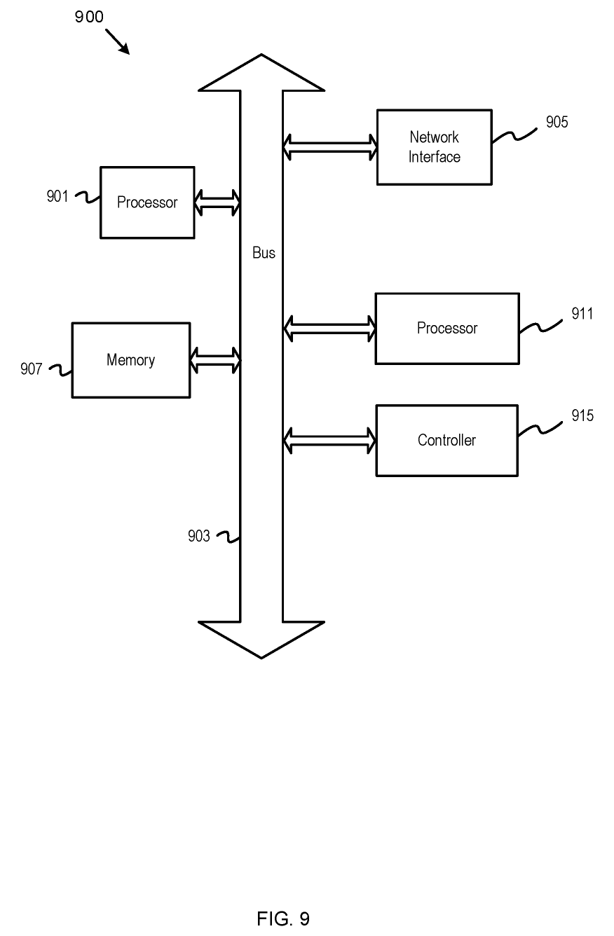

The well system 100 includes a computer 170 that may be communicatively coupled to other parts of the well system 100. The computer 170 may be local or remote to the drilling platform 110. A processor of the computer 170 may perform operations and data processing (as further described below). In some implementations, the processor of the computer 170 may control drilling operations of the well system 100 or subsequent drilling operations of other wellbores. For instance, the processor of the computer 170 may generate digitized data files for the geological formations 130, 132 based on the measurements obtained from the drilling assembly 116 and subsequently perform a wellbore operation based on the digitized data files. An example of the computer 170 is depicted in FIG. 9, which is further described below.

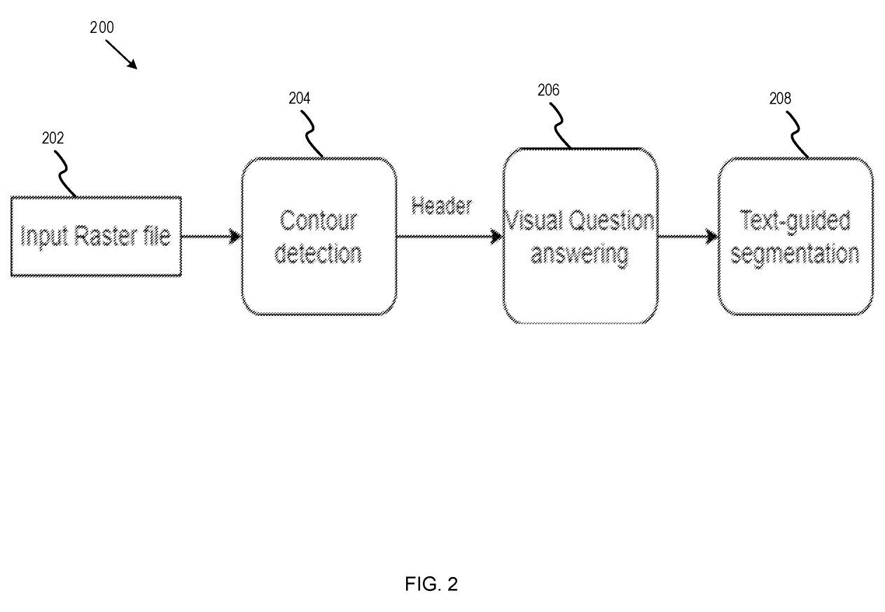

FIG. 2 describes the digitization of data originally in TIFF files at a high general level, specifically in a four step series. Data from well logs, such as may be taken from well system 100 is provided in a TIFF file. The well log data may be obtained from tools positioned on the drilling assembly such as the logging-while-drilling (LWD) tool or measuring-while-drilling (MWD) tools. Alternatively, or in addition to, the measurements may also be interpolated from offset wellbore logs. The measurements may determine properties of the rock itself (such as the rock density, rock porosity, etc.) and/or properties of the fluid within the rock (such as resistivity of the fluid within the pores of the rock).

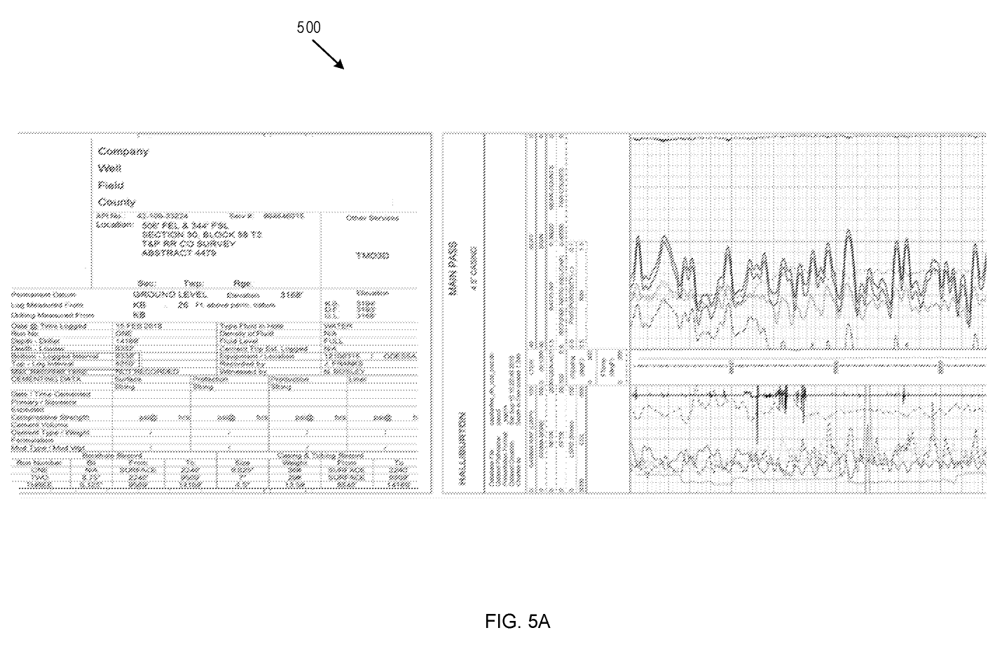

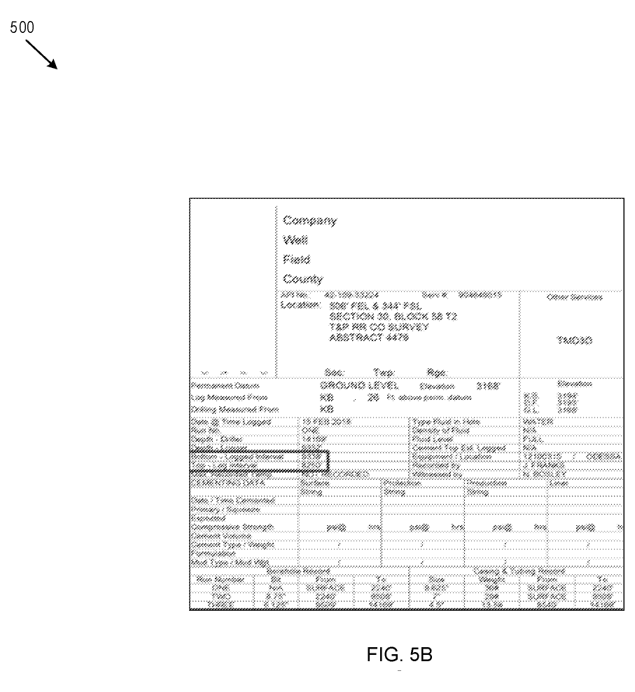

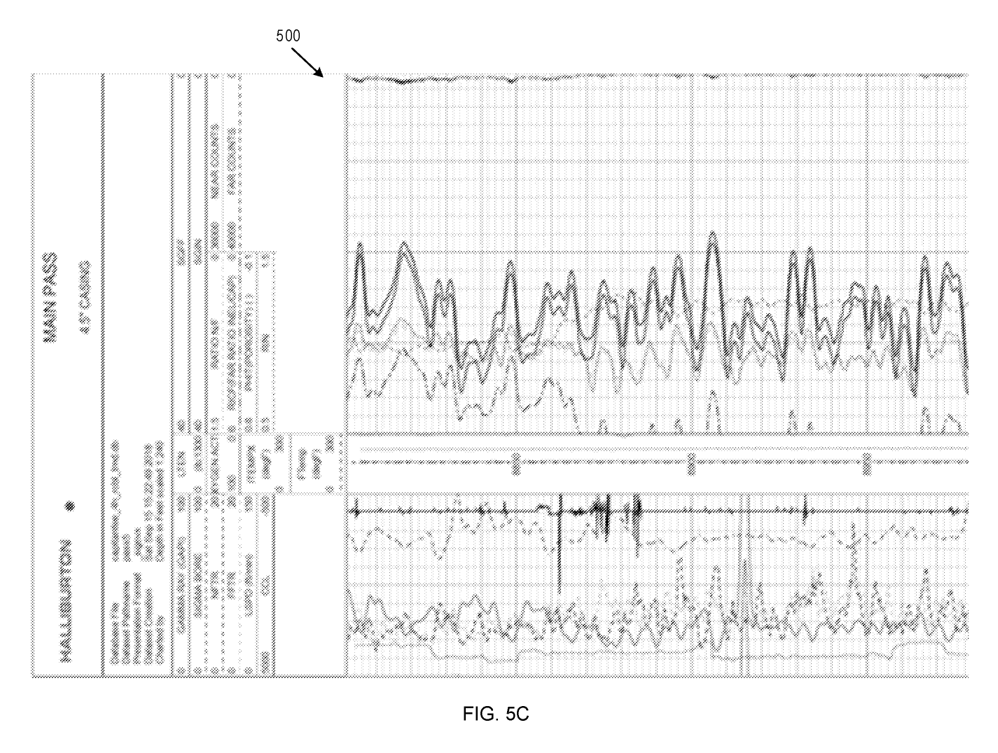

In a first step 202, the TIFF file may be input into a computer, which may include a language learning model. In a the contour detection step 204, a contour detection pipeline is performed on a plot area within the TIFF file to merge overlapping contours. The contour detection produces bounding boxes (as shown in the example images in FIGS. 5A-5C). Using the bounding boxes, the plot region may be separated from the headers. The headers are needed to perform visual question answering (VQA) in a VQA 206. VQA is used to process multiple plots in a single image. A text-guided segmentation step 208 is used to segment the curve specific information from the plot region.

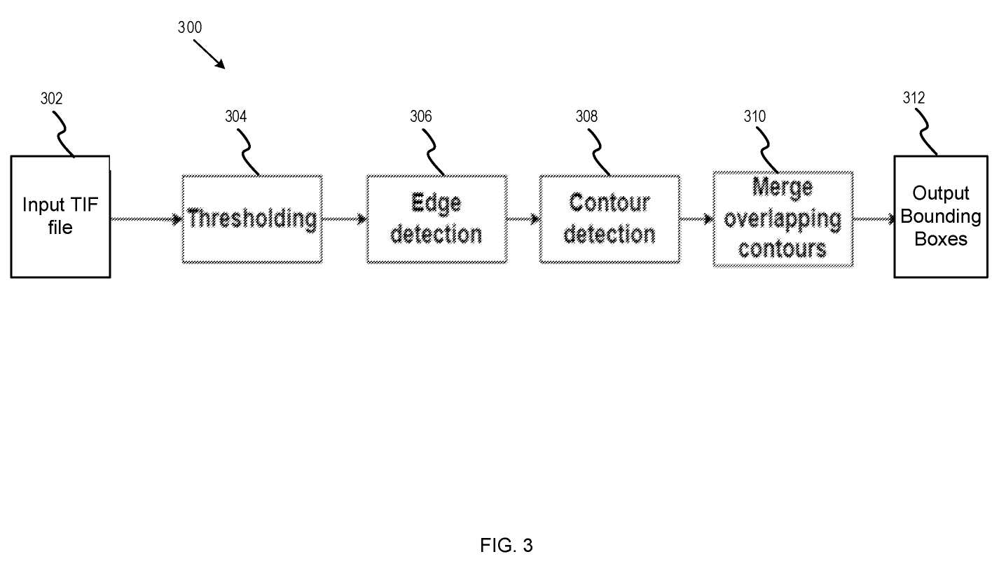

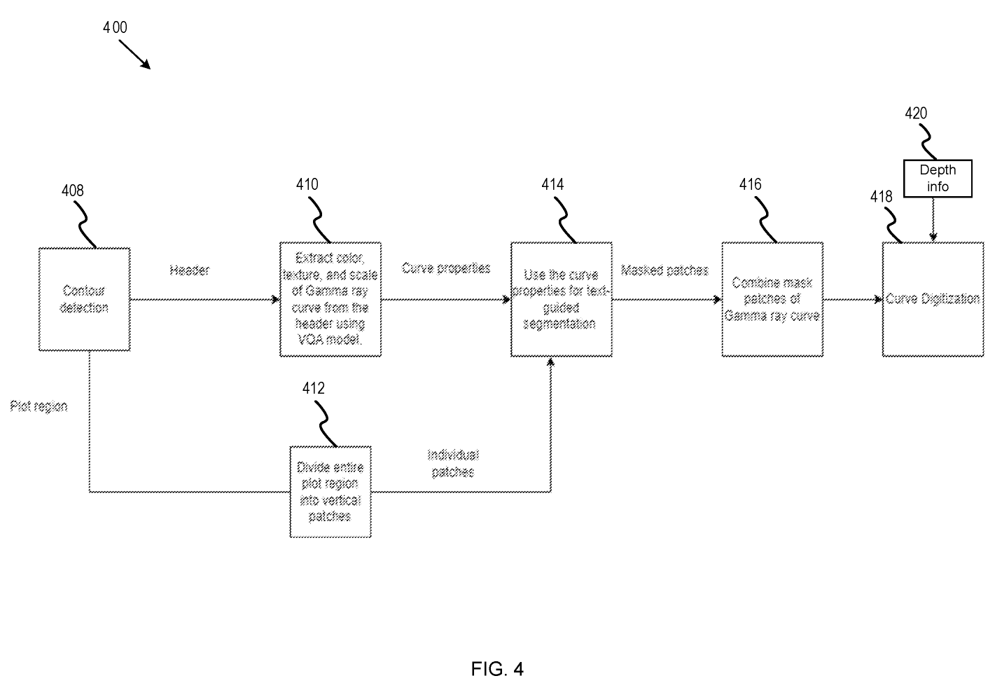

FIG. 3 and FIG. 4 illustrate the steps of FIG. 2 in more detail. FIG. 3 is a more detailed illustration of the contour detection step 204. FIG. 4 illustrates a workflow 400 describing the VQA 206 and text-guided segmentation step 208 processes described in FIG. 2.

In a step 408, Extracted plot regions and headers are extracted using the contour detection pipeline 300 discussed in FIG. 3, which produce bounding boxes. The headers obtained are further filtered for important and specific information related to the user-desired curve in the VQA step 410. VQA may extract at least color, texture, and scale of the curve from the header. Depth information 420 (log depth within the well) is also extracted VQA may be performed with a multi-modal modeling platform, such as GPT-4o, or using a large vision language model. In some examples, a prompt may given by the user for the VQA, and when using a large vision language model, the model may be taught with demonstrations of what the output should look like, such as type of curve, type of line (dotted/solid/color/dashed) to guide the model to answer the prompts usually answered by the user such that the process may be fully automated.

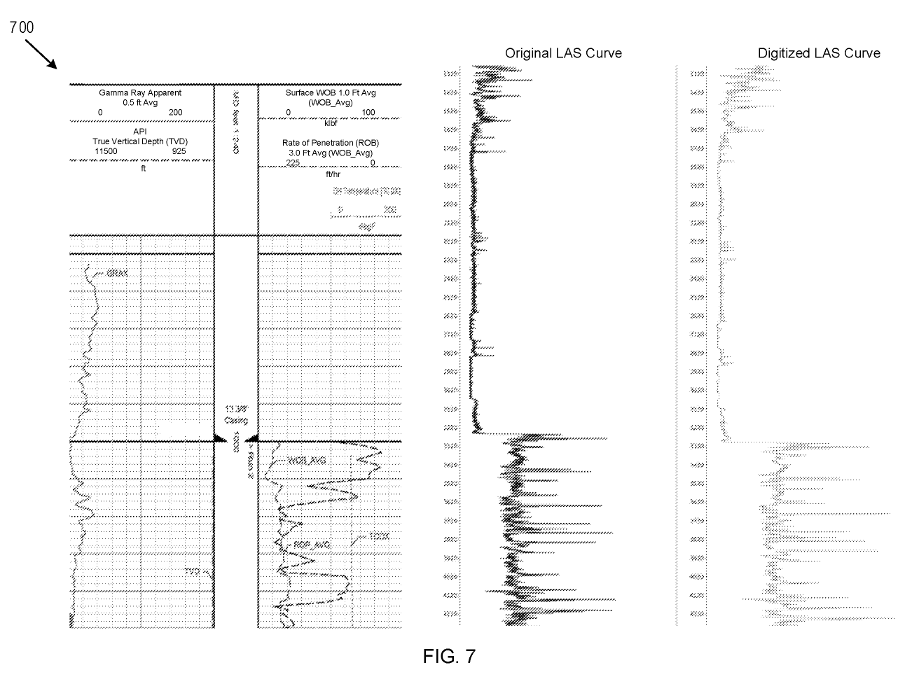

At a VQA step 412, a plot region may be extracted from the bounding boxes. The entire plot region may be divided into individual vertical patches and depth information 420 may be extracted. The curve properties extracted from the header in VQA step 410 using VQA and the extracted plot regions are then used together for text-guided segmentation in step 414. The mask of the individual patches (such as one illustrated in FIG. 7) are combined in step 416. In step 418, the combined masks of the patches are digitized based on pixel positions and normalization. The digitization includes centroid calculation and normalization, which includes assigning values to the non-zero pixels based on their position in the mask, and using centroid calculation and normalization, utilizing the scale and depth values extracted in the VQA steps 410 and 412. Finally, the digitized data is written to the LAS format.

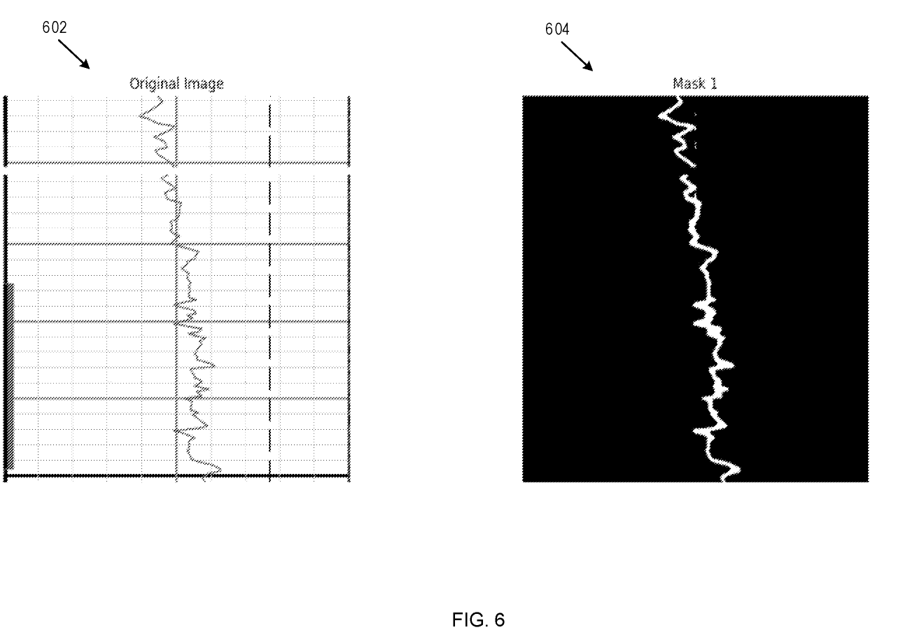

At a step 414, the extracted curve properties are used for text-guided segmentation. to segment the curve specific information from the plot region. Three main components include an image encoder, prompt encoder, and a mask decoder. A pretrained vision transformer may be used as the image encoder. FIG. 6 illustrates an example of an image 602 of the curve transformed into a binary mask of the curve, shown in image 604. Although the Figures are presented in black and white, the TIFF files may include several colors and line variations, such as a green curve, dotted curve, blue curve, etc. The Mask decoder uses a modified transformer decoder block followed by a dynamic mask prediction head. This is done in the following steps: 1) color thresholding to remove gridlines and other curves from the image; 2) dilate the curve with a kernel size (e.g. 3) to improve the quality of segmentation.

FIGS. 5A-5C are example images of bounding boxes obtained for various headers and plot region after contour detection. FIG. 5A is broken into FIGS. 5B and 5C for more detailed views. These images include text, but the text is not intended for reference or use with the specification herein – it is merely representative of example data images obtained during part of the solution presented herein.

FIG. 6 illustrates a mask obtained from one individual patch of the plot region illustrated in FIG. 5C. Image 602 illustrates the original image. Image 604 illustrates the mask of the patch.

FIG. 7 illustrates the robustness of the disclosed solution. The TIFF data is shown along with a hand-extracted original LAS data curve along with a digitized LAS curve according to the solution according to the described provided in FIGS. 2-4.

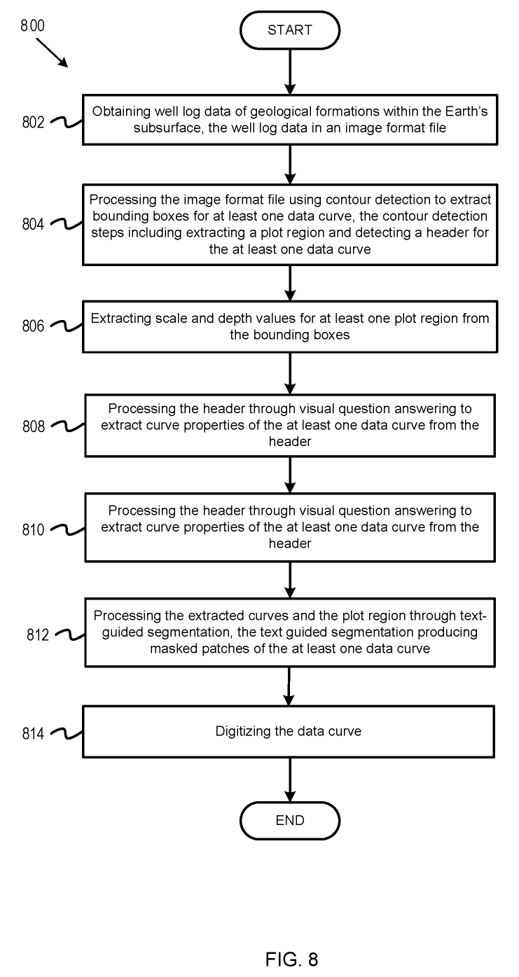

FIG. 8 is a flowchart depicting example operations to configure a learning machine, according to some implementations. FIG. 8 includes a flowchart of a method 800 for converting well log data from a large image format file (such as a TIFF file) into digitized data. Operations of the method 800 of FIG. 8 are described in reference to the processor of the computer 170 of FIG. 1. Operations of the method 800 start at block 802.

At block 802, the processor of the computer 170 (hereinafter “processor”) may obtain well log data related to one or more geological formations within the Earth’s subsurface, wherein the plurality of well log data is contained in an image format file. The well log data may be taken while drilling a wellbore, or from surrounding subterranean formations.

At block 804 the processor may process the image format (TIF) file using contour detection to extract bounding boxes for at least one data curve. The contour detection may include several processing steps, including thresholding the data, detecting edges within the data, extracting a plot region, merging overlapping contours and boundaries, and detecting a header for the at least one data curve.

At block 806, the processor may extract scale and depth values for at least one plot region from the bounding boxes.

At block 808, the processor processes the header through visual question answering to extract curve properties of the at least one data curve from the header.

At block 810, the processor processes the extracted curves and the plot region through text-guided segmentation. The plot region may be divided into vertical patches and then the individual patches are extracted. The text-guided segmentation produces masked patches of the at least one data curve.

At block 812, the curve is digitized and may be presented in an LAS format. The digitization may include assigning values to non-zero pixels based on their position in the mask and utilizing the scale and depth values for the plot region extracted from the bounding boxes.

The method ends after block 814.

While the aspects of the disclosure are described with reference to various implementations and exploitations, it will be understood that these aspects are illustrative and that the scope of the claims is not limited to them. In general, techniques for generating realistic geology maps as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example process in the form of a flow diagram. However, some operations may be omitted and/or other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described should not be understood as requiring such separation in all implementations, and the described program components and systems may generally be integrated together in a single software product or packaged into multiple software products. Additionally, other implementations are within the scope of the following claims. In some cases, the actions recited in the claims may be performed in a different order and still achieve desirable results.

### Example Computer

FIG. 9 is a block diagram depicting an example computer, according to some implementations. FIG. 9 depicts a computer 900 for classification of system tracts. The computer 900 includes a processor 901 (possibly including multiple processors, multiple cores, multiple nodes, and/or implementing multi-threading, etc.). The computer 900 includes memory 907. The memory 907 may be system memory or any one or more of the above already described possible realizations of machine-readable media. The computer 900 also includes a bus 903 and a network interface 905. The computer 900 can communicate via transmissions to and/or from remote devices via the network interface 905 in accordance with a network protocol corresponding to the type of network interface, whether wired or wireless and depending upon the carrying medium. In addition, a communication or transmission can involve other layers of a communication protocol and or communication protocol suites (e.g., transmission control protocol, Internet Protocol, user datagram protocol, virtual private network protocols, etc.).

The computer 900 also includes a processor 911 and a controller 915 which may perform the operations described herein. For example, the processor 911 may process Raster logs of well log data received from a wellbore or subterranean surface. The Raster logs may be in large image format files, such as TIFF files, and the processor may process and digitize the Raster logs according to the solutions provided herein, such as described in FIGS. 2-4 and the method 800 in FIG. 8. The digitized data may be presented in LAS files, which may then be used for further processing – for wellbore planning, updating or modifying a wellbore operation, or training large vision language models for future data processing and wellbore planning.

The controller 915 may, in some examples, perform or direct a wellbore operation based on the digitized data. The processor 911 and the controller 915 can be in communication. For example, the digitized data may be used to modify an existing wellbore by modifying drilling operations or updating the wellbore plan, and many other operations that may be affected and benefit from better data available from within the wellbore. Any one of the previously described functionalities may be partially (or entirely) implemented in hardware and/or on the processor 901. For example, the functionality may be implemented with an application specific integrated circuit, in logic implemented in the processor 901, in a co-processor on a peripheral device or card, etc. Further, realizations may include fewer or additional components not illustrated in FIG. 9 (e.g., video cards, audio cards, additional network interfaces, peripheral devices, etc.). The processor 901 and the network interface 905 are coupled to the bus 903. Although illustrated as being coupled to the bus 903, the memory 907 may be coupled to the processor 901.

### Example Implementations

Aspects disclosed herein include:

Aspect A: A computer-implemented method, the computer-implemented method comprising: obtaining well log data related to one or more geological formations within the Earth's subsurface, wherein the well log data is contained in an image format file; processing the image format file using contour detection to extract bounding boxes for at least one data curve, the contour detection including extracting a plot region, and detecting a header for the at least one data curve; extracting scale and depth values for at least one plot region from the bounding boxes; processing the header through visual question answering to extract curve properties of the at least one data curve from the header; processing the extracted curves and the plot region through text-guided segmentation, the text-guided segmentation producing masks of individual patches of the at least one data curve; and digitizing the data curve.

Aspect B: A non-transitory, computer-readable medium having instructions stored thereon that are executable by a processor, the instructions including: instructions to obtain well log data related to one or more geological formations within the Earth's subsurface, wherein the well log data is contained in an image format file; instructions to process the image format file using contour detection to extract bounding boxes for at least one data curve, the contour detection including extracting a plot region, and detecting a header for the at least one data curve; instructions to extract scale and depth values for at least one plot region from the bounding boxes; instructions to process the header through visual question answering to extract curve properties of the at least one data curve from the header; instructions to process the extracted curves and the plot region through text-guided segmentation, the text-guided segmentation including instructions to producing a mask for individual patches of the at least one data curve; and instructions to digitize the data curve.

Aspect C: A system comprising: a processor; and a computer-readable medium having instructions stored thereon that are executable by the processor, the instructions including: instructions to obtain well log data related to one or more geological formations within the Earth's subsurface, wherein the well log data is contained in an image format file; instructions to process the image format file using contour detection to extract bounding boxes for at least one data curve, the contour detection including extracting a plot region, and detecting a header for the at least one data curve; instructions to extract scale and depth values for at least one plot region from the bounding boxes; instructions to process the header through visual question answering to extract curve properties of the at least one data curve from the header; instructions to process the extracted curves and the plot region through text-guided segmentation, the text-guided segmentation producing masks for individual patches of the at least one data curve; and instructions to digitize the data curve.

Aspects A, B, and C may have one or more of the following additional features in combination:

Feature 1: wherein digitizing the data curve includes assigning values to non-zero pixels based on their position in the masks and utilizing the scale and depth values for the plot region extracted from the bounding boxes.

Feature 2: wherein the digitized data curve is presented as a Log ASCII standard (LAS) file.

Feature 3: wherein the contour detection further includes edge detection of the well log data and merging overlapping contours.

Feature 4: wherein the visual question answering is based on curve properties of the data curve specified by a user.

Feature 5: wherein the visual question answering is integrated as a prompt with the text-guided segmentation.

Feature 6: wherein the method may be implemented in a large vision language model.

Feature 7: further comprising using the digitized data curve for modeling the one or more geological formations.

Feature 8: performing a wellbore operation based on the digitized data curve.

Feature 9: wherein the instructions to digitize the data curve includes assigning values to non-zero pixels based on their position in the mask and utilizing the extracted scale and depth values for the plot region extracted from the bounding boxes.

Feature 10: wherein the digitized curve is presented as a Log Ascii standard (LAS) file.

Feature 11: wherein the instructions to process the image format file using contour detection further include instructions to detect edges of the well log data and instructions to merge overlapping contours.

Feature 12: wherein the instructions to process the header through visual question answering is based on curve properties of the data curve specified by a user.

Feature 13: wherein the instructions to process the header through visual question answering is integrated as a prompt with the text-guided segmentation.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

As used herein, the term “or” is inclusive unless otherwise explicitly noted. Thus, the phrase “at least one of A, B, or C” is satisfied by any feature from the set {A, B, C} or any combination thereof, including multiples of any feature or element.

Those skilled in the art to which this application relates will appreciate that other and further additions, deletions, substitutions and modifications may be made to the described embodiments.

1. A computer-implemented method, the computer-implemented method comprising:
obtaining well log data related to one or more geological formations within the Earth’s subsurface, wherein the well log data is contained in an image format file;
processing the image format file using contour detection to extract bounding boxes for at least one data curve, the contour detection including
extracting a plot region, and
detecting a header for the at least one data curve;
extracting scale and depth values for at least one plot region from the bounding boxes;
processing the header through visual question answering to extract curve properties of the at least one data curve from the header;
processing the extracted curves and the plot region through text-guided segmentation, the text-guided segmentation producing masks of individual patches of the at least one data curve; and
digitizing the data curve.

2. The computer-implemented method of claim 1, wherein digitizing the data curve includes assigning values to non-zero pixels based on their position in the masks and utilizing the scale and depth values for the plot region extracted from the bounding boxes.

3. The computer-implemented method of claim 1, wherein the digitized data curve is presented as a Log ASCII standard (LAS) file.

4. The computer-implemented method of claim 1, wherein the contour detection further includes edge detection of the well log data and merging overlapping contours.

5. The computer-implemented method of claim 1, wherein the visual question answering is based on curve properties of the data curve specified by a user.

6. The computer-implemented method of claim 1, wherein the visual question answering is integrated as a prompt with the text-guided segmentation.

7. The computer-implemented method of claim 1, wherein the method may be implemented in a large vision language model.

8. The computer-implemented method of claim 1, further comprising using the digitized data curve for modeling the one or more geological formations.

9. The computer-implemented method of claim 1 further comprising:
performing a wellbore operation based on the digitized data curve.

10. A non-transitory, computer-readable medium having instructions stored thereon that are executable by a processor, the instructions including:
instructions to obtain well log data related to one or more geological formations within the Earth’s subsurface, wherein the well log data is contained in an image format file;
instructions to process the image format file using contour detection to extract bounding boxes for at least one data curve, the contour detection including
extracting a plot region, and
detecting a header for the at least one data curve;
instructions to extract scale and depth values for at least one plot region from the bounding boxes;
instructions to process the header through visual question answering to extract curve properties of the at least one data curve from the header;
instructions to process the extracted curves and the plot region through text-guided segmentation, the text-guided segmentation including instructions to producing a mask for individual patches of the at least one data curve; and
instructions to digitize the data curve.

11. The non-transitory, computer-readable medium of claim 10, wherein the instructions to digitize the data curve includes assigning values to non-zero pixels based on their position in the mask and utilizing the extracted scale and depth values for the plot region extracted from the bounding boxes.

12. The non-transitory, computer-readable medium of claim 10 wherein the digitized data curve is presented as a Log Ascii standard (LAS) file.

13. The non-transitory, computer-readable medium of claim 10, wherein the instructions to process the image format file using contour detection further include instructions to detect edges of the well log data and instructions to merge overlapping contours.

14. The non-transitory, computer-readable medium of claim 10, wherein the instructions to process the header through visual question answering is based on curve properties of the data curve specified by a user.

15. The non-transitory, computer-readable medium of claim 10, wherein the instructions to process the header through visual question answering is integrated as a prompt with the text-guided segmentation.

16. A system comprising:
a processor; and
a computer-readable medium having instructions stored thereon that are executable by the processor, the instructions including:
instructions to obtain well log data related to one or more geological formations within the Earth’s subsurface, wherein the well log data is contained in an image format file;
instructions to process the image format file using contour detection to extract bounding boxes for at least one data curve, the contour detection including
extracting a plot region, and
detecting a header for the at least one data curve;
instructions to extract scale and depth values for at least one plot region from the bounding boxes;
instructions to process the header through visual question answering to extract curve properties of the at least one data curve from the header;
instructions to process the extracted curves and the plot region through text-guided segmentation, the text-guided segmentation producing masks for individual patches of the at least one data curve; and
instructions to digitize the data curve.

17. The system of claim 16, wherein the instructions to digitize the data curve includes instructions to assign values to non-zero pixels based on their position in the masks and instructions to utilize the extracted scale and depth values for the plot region extracted from the bounding boxes, and wherein the digitized data curve is presented as a Log ASCII standard (LAS) file.

18. The system of claim 16, wherein the instructions to process the image format file using contour detection further includes instructions to detect edges of the well log data and instructions to merge overlapping contours.

19. The system of claim 16, wherein the instructions to process the header through visual question answering is based on curve properties of the data curve specified by a user.

20. The system of claim 16, wherein the instructions to process the header through visual question answering is integrated as a prompt with the text-guided segmentation.
